(19) United States
(12) Patent Application Publication
(10) Pub. No.: US 2007/0150103 A1
(43) Pub. Date: Jun. 28, 2007

(54) Positioning method and system for indoor moving robot

(75) Inventors: Sung Ho Im, Daejeon-city (KR); Dong Sun Lim, Daejeon-city (KR); Kee Koo Kwon, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/635,368

(22) Filed: Dec. 7, 2006

(30) Foreign Application Priority Data
Dec. 8, 2005 (KR) 10-2005-0120007
Jul. 20, 2006 (KR) 10-2006-0068157

(51) Int. Cl. G06F 19/00

(52) U.S. Cl. 700/245

(57) ABSTRACT

A positioning device and method using two transmirrors for positioning a moving robot which moves in an indoor environment is provided. The positioning device includes a transmitter transmitting signals to first and second transmirrors; a receiver receiving signals from the first and second transmirrors; and a positioning unit determining the position of the moving robot based on time intervals between time points when signals are transmitted to the first and second transmirrors and time points when signals are received from the first and second transmirrors. Accordingly, the number of transmirrors can be reduced, and synchronization between the moving robot and the transmirrors is not needed, so that it is possible to easily implement the positioning with lower cost.

### CROSS-REFERENCE TO RELATED PATENT APPLICATION

This application claims the benefits of Korean Patent Application No. 10-2005-0120007, filed on Dec. 8, 2005, and Korean Patent Application No. 10-2006-0068157, filed on Jul. 20, 2006, in the Korean Intellectual Property Office, the disclosures of which are incorporated herein in their entirety by reference.

### BACKGROUND OF THE INVENTION

1. Field of the Invention

The present invention relates to a positioning system and method for an indoor moving robot, and more particularly, to a positioning system and method for an indoor moving robot using two transmirrors.

2. Description of Related Art

Positioning methods for a moving robot are classified into relative positioning method and absolute positioning methods. Common relative positioning methods use an encoder attached to a wheel or a camera. Relative positioning method suffer from errors caused by sliding or idling of the wheel, errors according to the brightness of illumination or similarity of object shapes, and the fact that such errors tend to accumulate.

Relative positioning methods are complemented and improved by absolute positioning methods. Common absolute positioning methods use an infrared signal or an ultrasonic wave signal, or measure the intensity of a radio frequency (RF) signal.

In the method using the infrared signal, an infrared sensor is provided on a ceiling, and the moving robot has an infrared transmitter. The infrared transmitter periodically transmits an infrared identification signal toward the ceiling, and the position of the moving robot is measured using the received signal. This method has low resolution, and can be blocked by obstacles such as furniture. Therefore, it is used for positioning of a moving robot near the transmitter, instead of accurate positioning.

In the positioning method of measuring the intensity of the RF signal, the intensities of RF data signals transmitted from a base station, a transmission unit of a broadcast station, or an access point (AP) in a wireless LAN are measured at measuring points, and their intensities are analyzed statistically. By using the result of the analysis, the intensity of the RF signal is measured at a current point to position the moving robot. However, since the intensity of the RF signal changes with temperature, humidity, and other environmental factors, the accuracy of this method is limited to 1 m to 3 m, making it unsuitable for accurately positioning the indoor moving robot.

In the positioning method using the ultrasonic wave signal, an ultrasonic wave receiver is provided on a ceiling, and an ultrasonic wave generator is attached to the moving robot. The time taken for the ultrasonic wave to propagate from the ultrasonic wave generator to the ultrasonic wave receiver is measured, and used to calculate the distance therebetween. The positioning of the moving robot is performed by using the delay of signals received by several receivers, based on the distances. This method is relatively accurate, since sound waves such as ultrasonic waves have a low propagation speed, which enhances the propagation delay. However, the method has a problem in that the positioning is greatly influenced by obstacles such furniture.

### SUMMARY OF THE INVENTION

The present invention provides an absolute positioning system and method for positioning a moving robot, wherein transmirrors use UWB signals.

The present invention also provides a positioning system capable of being implemented with simple construction and lower cost, since synchronization between a moving robot and a sensor provided on a ceiling is not needed, since the number of sensors can be reduced to less than three, since the sensors can be located along a straight line, unlike an existing positioning system using the UWB signals.

According to an aspect of the present invention, there is provided a positioning system including: a first transmirror delaying a received signal by a predetermined time interval [symbol] T1 and transmitting the signal; a second transmirror delaying the received signal by a time interval [symbol] T2 and transmitting the signal; and a moving robot determining its own position based on time intervals between time points of transmitting signals to the first and second transmirrors and time points of receiving the signals from the first and second transmirrors.

In the above aspect of the present invention, the first and second transmirrors may be located along the same straight surface of a wall, and the straight surface of the wall may be aligned with an outmost moving course of the moving robot.

In addition, the current position of the moving robot may be calculated using the following equations:
(x−X1)²+(y−Y1)²+Z1²=(c*(T1−T1))²; and
(x−X2)²+(y−Y2)²+Z2²=(c*(T2−T2))², and
wherein (x, y, 0) represents the current position of the moving robot, (X1, Y1, Z1) represents the position of the first transmirror, (X2, Y2, Z2) represents the position of the second transmirror, T1 is the time interval between the time point when the moving robot transmits a signal to the first transmirror and the time point when the moving robot receives a signal from the first transmirror, T2 is the time interval between the time point when the moving robot transmits a signal to the second transmirror and the time point when the moving robot receives a signal from the second transmirror, and c is the propagation speed of the signals.

According to anther aspect of the present invention, there is provided a moving robot having a positioning device, wherein first and second transmirrors are located along a straight surface of a wall which is aligned with an outmost moving course of the moving robot, the moving robot including: a transmitter transmitting signals to the first and second transmirrors; a receiver receiving signals from the first and second transmirrors; and a positioning unit which positions the moving robot based on the time intervals between the time points when signals are transmitted to the first and second transmirrors and the time points when signals are received from the first and second transmirrors.

According to another aspect of the present invention, there is provided a positioning method for a moving robot which moves in an indoor environment where first and second transmirrors are provided, the positioning method including: transmitting signals from the moving robot to the first and second transmirrors; delaying the signals in the first and second transmirrors by time intervals [symbol] T1 and [symbol] T2, and then transmitting the signals to the moving robot; and determining the position of the moving robot based on the time intervals between the time points of transmitting the signals to the first and second transmirrors and the time points of receiving the signals from the first and second transmirrors.

### BRIEF DESCRIPTION OF THE DRAWINGS

The above and other features and advantages of the present invention will become more apparent by describing in detail exemplary embodiments thereof with reference to the attached drawings in which:

FIG. 1 shows the configuration of a positioning system in a moving robot according to an embodiment of the present invention;

FIG. 2 shows a concept of distance calculation at a time of indoor positioning in a moving robot;

FIG. 3 shows the internal configuration of a positioning system according to an embodiment of the present invention;

FIG. 4 shows the flow of signals between a moving robot and transmirrors in a positioning process according to an embodiment of the present invention; and

FIG. 5 is a flowchart illustrating a positioning method in a moving robot using transmirrors.

### DETAILED DESCRIPTION OF THE INVENTION

Exemplary embodiments of the present invention will now be described in detail with reference to the accompanying drawings. Like reference numerals denote like elements in the drawings. In the description of the present invention, well-known functions and constructions may be omitted for clarity and brevity.

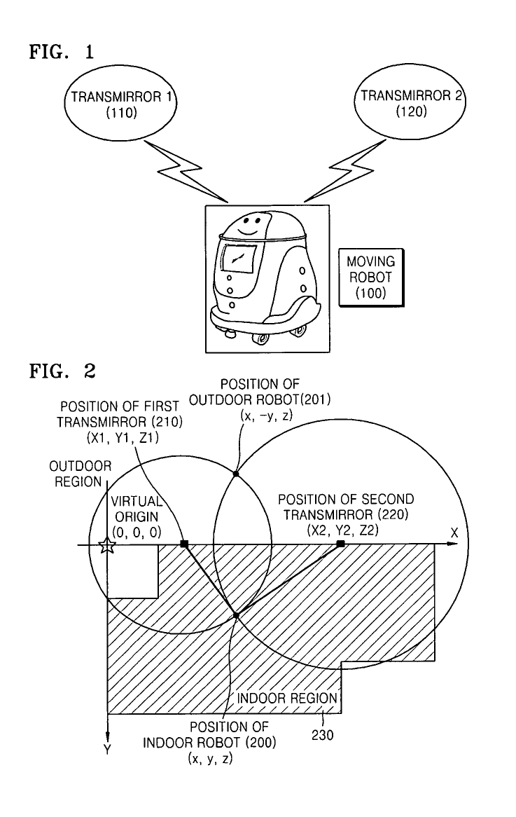

FIG. 1 shows the configuration of a positioning system in a moving robot 100 according to an embodiment of the present invention. In FIG. 1, a moving robot 100 moves in an indoor environment and performs positioning using two transmirrors.

In the embodiment of the present invention, the operating environment of the moving robot 100 is limited to indoors, and first and second transmirrors 110 and 120 are located along an outermost straight course (for example, a straight surface of a wall (not shown) of the moving robot 110.

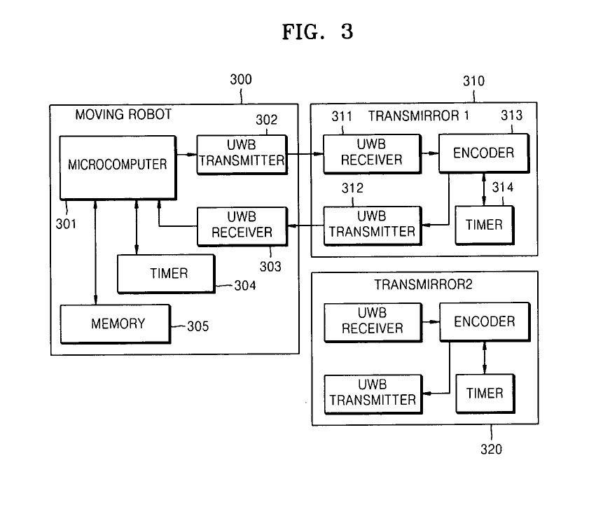

In general, three transmirrors are used to position the moving robot 110. However, in the embodiment of the present invention, since the operation environment of the moving robot 110 is limited to indoors, two transmirrors can be used, reducing the cost of implementing the positioning of the indoor moving robot 110. In addition, delay time intervals [symbol] T1 and [symbol] T2 of the transmirrors, which can easily have errors, can be accurately calculated, and a predetermined value can be corrected, so that the errors can be minimized. A positioning method of the moving robot using only two transmirrors is described in detail with reference to FIG. 2.

The positioning system according to the embodiment of the present invention includes the moving robot 100 and the first and second transmirrors 110 and 120.

In the positioning system, the moving robot 100 is a target of the positioning, and the first and second transmirrors 110 and 120 are beacon devices which process signals for positioning the moving robot 100.

The moving robot 100 transmits positioning request signals to the first and second transmirrors 110 and 120. The first and second transmirrors 110 and 120 receive the positioning request signals transmitted from the moving robot 100 and transmit positioning response signals to the moving robot 100 after time intervals [symbol] T1 and [symbol] T2.

The time intervals [symbol] T1 and [symbol] T2 are defined to be longer than both of the time intervals spent on receiving and transmitting the signals by the first and second transmirrors 110 and 120.

The moving robot 100 calculates time intervals [symbol] T1 and [symbol] T2 between time points T₁ₜᵣₐₙₛₘᵢᵣᵣₒᵣ and T₂ₜᵣₐₙₛₘᵢᵣᵣₒᵣ when the positioning request signals are transmitted to the first and second transmirrors 110 and 120 and time points T_{1moving} and T_{2moving} when the moving robot 100 receives the positioning response signals from the first and second transmirrors 110 and 120.

T1 is the time interval between the time point when the moving robot 100 transmits the positioning request signal to the first transmirror 110 and the time point when the moving robot 100 receives the positioning response signal from the first transmirror 110 (T1=T_{1moving}−T₁ₜᵣₐₙₛₘᵢᵣᵣₒᵣ), and similarly, T2 is a time interval between the time point when the moving robot 100 transmits the positioning request signal to the second transmirror 120 and the time point when the moving robot 100 receives the positioning response signal from the second transmirror 120 (T2=T_{2moving}−T₂ₜᵣₐₙₛₘᵢᵣᵣₒᵣ).

Next, the distances from the moving robot 100 to the first and second mirrors 110 and 120 are calculated by using time intervals T1− [symbol] T1 and T2− [symbol] T2 obtained by subtracting delay time intervals [symbol] T1 and [symbol] T2 of the first and second transmirrors 110 and 120 from the time intervals T1 and T2. The calculation of the distances is described in detail with reference to FIG. 2.

According to the embodiment of the present invention, an ultra wide band (UWB) signal communication scheme is used for positioning request signal transmission and positioning response signal reception between the moving robot 100 and the first and second transmirrors 110 and 120. Namely, the positioning request signals transmitted from the moving robot 100 to the transmirrors 110 and 120 and the positioning response signals transmitted from the transmirrors 110 and 120 to the moving robot 100 are the UWB signals.

The positioning system using the UWB scheme is similar to a positioning system using an ultrasonic wave signal. However, since the UWB scheme has a very high spatial resolution, a time taken for the moving robot to move can be accurately estimated. Therefore, the UWB scheme is suitable for the positioning system. In addition, since the UWB signal has a low central frequency for operation, it has an excellent transmittance, so that a high position accuracy can be obtained even in a shadowed environment or an indoor environment, which is a non-line-of-sight (non-LOS) situation. Moreover, unlike an infrared scheme or an ultrasonic scheme where the transmirrors needs to be separately provided to a closed space, since the UWB signal can be transmitted through a wall, it is possible to reduce the number of transmirrors.

In addition, unlike an RF communication technique, since a carrier wave is not used, an IF module is not needed. Therefore, the positioning system according to the embodiment of the present invention can be designed in a simple wireless communication construction, so that the positioning system has been expected to be very useful.

The UWB signal is an exemplary signal used for the present invention. Therefore, it should be noted that the present invention is not limited thereto, and other signals may be used.

According to the present invention, a separate synchronization unit or method is not needed for the moving robot 100 to synchronize the positioning response signals received from the first and second transmirrors 110 and 120. The synchronization is adjusted based on a setting value of the moving robot 100, so that it is possible to minimize errors.

FIG. 2 shows a concept of distance calculation at a time of indoor positioning in a moving robot 200.

The moving course of the moving robot 200 is limited within an indoor region 230, and two transmirrors 210 and 220 are located along an outmost straight course (for example, a straight surface of a wall) of the moving robot 200. The moving robot 200 transmits positioning request signals in the form of UWB signals to the first and second transmirrors 210 and 220 and then receives positioning response signals in the form of UWB signals from the first and second transmirrors 210 and 220. Next, the distances r1 and r2 from the moving robot. 200 to the first and second transmirrors 210 and 220 are calculated by using time intervals T1− [symbol] T1 and T2− [symbol] T2 obtained by subtracting delay time intervals a [symbol] T1 and [symbol] T2 of the first and second transmirrors 110 and 120 from time intervals T1 and T2.

The distances r1 and r2 from the moving robot 200 to the first and second transmirrors 210 and 220 are calculated using Equation 1. In Equation 1, the propagation speed of the signals transmitted and received between the moving robot and the first and second transmirrors 210 and 220 are denoted by c.

[Equation 1]
r1=c*(T1−T1)
r2=c*(T2−T2).

In Equation 1, T1 is the time interval between the time point when the moving robot 200 transmits the positioning request signal to the first transmirror 210 and the time point when the moving robot 200 receives the positioning response signal from the first transmirror 210, and the T2 is the time interval between the time point when the moving robot 200 transmits the positioning request signal to the second transmirror 220 and the time point when the moving robot 200 receives the positioning response signal from the second transmirror 220.

The current position of the moving robot 200 is obtained using Equation 2. In Equation 2, (x, y, 0) represents the current position of the moving robot 200, (X1, Y1, Z1) represents the position of the first transmirror 210, and (X2, Y2, Z2) represents the position of the second transmirror 220.

[Equation 2]
(x−X1)²+(y−Y1)²+Z1²=r1²
(x−X2)²+(y−Y2)²+Z2²=r2²

By substituting Equation 1 into Equation 2, the following equations are obtained.
(x−X1)²+(y−Y1)²+Z1²=(c*(T1−T1))²
(x−X2)²+(y−Y2)²+Z2²=(c*(T2−T2))²

In the above two equations, it is assumed that the positions (X1, Y1, Z1) and (X2, Y2, Z2) of the first and second transmirrors 210 and 220 are known constant values, and the indoor region of the moving robot 200 is a flat area. Therefore, the current position of the moving robot 200 may be set to (x, y, 0).

Accordingly, the two equations are functions of the variables x and y, so that x and y can be obtained from the two equations. Since a negative value of y denotes the position of a virtual outdoor robot, a positive integer may be taken as the value of the y. Therefore, the positioning of the moving robot 200 can be performed by using the equations.

[Equation 3]

When the moving robot 200 is located just under the first transmirror 210, the following equations are obtained.
x−X1=0
x−X2=X1−X2=D (distance between transmirrors in the x direction)

Since y−Y1=y−Y2=0, by substituting the equations into Equation 2, the following equation is obtained. [symbol]
R²+Z1²=(c*(T1−T1))²

Since [symbol] D²+ [symbol] R²+Z2²=(c*(T2− [symbol] T2))², the delay time intervals [symbol] T1 and [symbol] T2 are obtained as follows. [symbol]
T1=T1−√(Z1²)/c [symbol]
T2=T2−√( [symbol] D²+Z2²)/c

Z1 and Z2 of the first and second transmirrors 210 and 220 and the distance between the first and second transmirrors 210 and 220 are known values at the time of installing the first and second transmirrors 210 and 220. Therefore, when the T1 and T2 are obtained, the delay time intervals [symbol] T1 and [symbol] T2 can be calculated from T1 and T2. Next, the error correction can be performed by using the calculated delay time intervals [symbol] T1 and [symbol] T2. In addition, when the moving robot 200 is located just under the second transmirror 220, similar calculations and error correction can be performed.

FIG. 3 shows the internal configuration of a positioning system according to an embodiment of the present invention;

A moving robot 300 includes a microcomputer 301, a UWB transmitter 302, a UWB receiver 303, a timer 304, and a memory 305. The microcomputer 310 obtains [symbol] T1 and [symbol] T2 accurately and processes signals to calculate the positions of the transmirrors 310 and 320. The UWB transmitter 302 is a module through which the moving robot 300 transmits signals to the transmirrors 310 and 320, and the UWB receiver 303 is a module through which the moving robot 300 receives results of processes from the transmirrors 310 and 320. The timer 304 is used to count the time interval between the time point when the UWB signal is transmitted and the time point when the positioning response signal is received. The memory is used to store the results of processes.

The first transmirror 310 includes a UWB receiver 311, a UWB transmitter 312, an encoder 313, and a timer 314. The UWB receiver 311 receives a signal from the moving robot 300 and transmits a result of processes through the UWB transmitter 312 to the moving robot 300.

The encoder 113 controls timings by using the timer 314 so that the UWB transmitter 312 transmits the positioning response signal after a specific time interval [symbol] T1 with respect to the positioning request signal received by the UWB receiver 311. The specific time interval [symbol] T1 is longer than the sum of a UWB signal receiving time, a received signal analyzing time, and a UWB signal transmitting time in the first transmirror 310, and the specific time interval [symbol] T1 needs to be set in the moving robot 300 in advance. The encoder 313 ensures that the time intervals can be calculated without separate synchronization between the moving robot 300 and the first and second transmirrors 310 and 320, so that the positioning can be easily performed. The second transmirror 320 has substantially the same construction and function as the first transmirror 310, and thus a detailed description thereof is omitted.

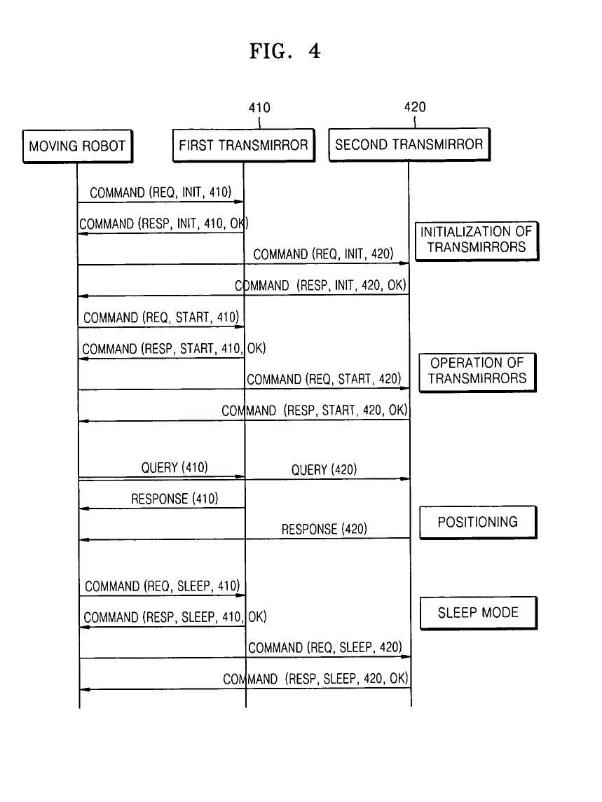

FIG. 4 shows the flow of signals between a moving robot and transmirrors in a positioning process according to an embodiment of the present invention.

The flow of signals is controlled by the moving robot. Since the operation and function of the first and second transmirrors are substantially the same, only the flow of signals between the moving robot and the first transmirror is described.

In a COMMAND (req, init, 410) signal which is used to initialize a positioning system, “req” denotes a request for positioning, “init” denotes initialization of the positioning system, and “410” is an identification number of a transmirror. When the positioning system in the mobile system is successfully initialized, the transmirror receiving the COMMAND signal transmits a COMMAND (resp, init, 410, OK) signal indicating the initialization of the positioning system to the moving robot, and assumes a standby mode. In the COMMAND (resp, init, 410, OK) signal, “resp” denotes response, “init” denotes initialization of the positioning system, “410” is the identification number of the transmirror, and “OK” or “NOK” denote success or failure of the initialization of the positioning system.

When the positioning starts, the moving robot transmits a COMMAND (req, start, 410) signal to the transmirror 410. The transmirror 410 receiving the COMMAND (req, start, 410) signal drives the positioning system in an execute mode and informs the moving robot that preparation is completed by using a COMMAND (resp, start, 410, OK) signal. After that, the transmirror 410 waits for a signal from the moving robot.

When the moving robot recognizes the execution of transmirror 410, the moving robot transmits the positioning request signal QUERY (410) to the transmirror 410. When receiving the positioning request signal, the transmirror 410 transmits the positioning response signal RESPONSE (410) signal after a time interval [symbol] T1. The moving robot calculates the time interval from the time point of transmitting the positioning response signal RESPONSE (410) and calculates the current location based on the time interval.

When the moving robot completes the positioning, it transmits a COMMAND (req, sleep, 410) signal to the transmirror 410. Next, when the transmirror 410 conveys a result of process to the moving robot by using a COMMAND (req, sleep, 410, OK) signal, the moving robot assumes a sleep mode. The sleep mode of the moving robot is used when the moving robot is in a charging station, is turned off, or does not move for a certain time.

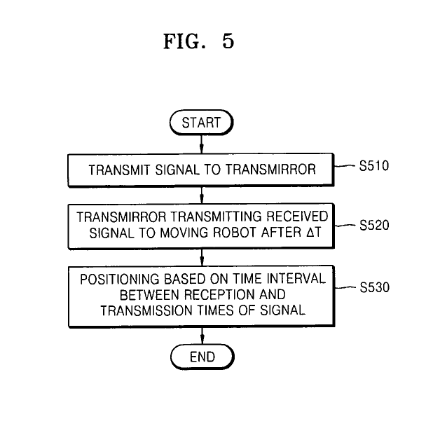

FIG. 5 is a flowchart illustrating a positioning method in a moving robot using transmirrors.

In order to position the moving robot in an indoor environment provided with first and second transmirrors, the moving robot transmits positioning request signals to the first and second transmirrors (S510).

After receiving the positioning request signals from the moving robot, the first and second transmirrors delay the received positioning request signals by time intervals [symbol] T1 and [symbol] T2 and transmit the signals to the moving robot (S520).

The moving robot calculates the time intervals between the time points when the positioning request signals were transmitted to the first and second transmirrors and the time points when the moving robot received the positioning response signals, and calculates the position of the moving robot based on the time intervals (S530). The calculation of the time intervals and the positioning based on the time intervals are the same as those described above with reference to FIGS. 1 and 2, and thus a description thereof is omitted.

The invention can also be embodied as computer readable code on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and detail may be made therein without departing from the spirit and scope of the present invention as defined by the appended claims.

According to the present invention, two transmirrors are used to position an indoor moving robot, so that it is possible to easily implement a positioning system and reduce cost of the positioning system. In addition, synchronization between the moving robot and the transmirrors is not needed, so that it is possible to simplify the positioning system.

What is claimed is:

1. A positioning system comprising:
a first transmirror delaying a received signal by a predetermined time interval [symbol] T1 and transmitting the signal;
a second transmirror delaying the received signal by a time interval [symbol] T2 and transmitting the signal; and
a moving robot determining its own position based on time intervals between time points of transmitting signals to the first and second transmirrors and time points of receiving the signals from the first and second transmirrors.

2. The positioning system of claim 1,
wherein the first and second transmirrors are located along the same straight surface of a wall, and
wherein the straight surface of the wall is aligned with an outmost moving course of the moving robot.

3. The positioning system of claim 1, wherein the time intervals [symbol] T1 and [symbol] T2 are longer than both time intervals spent on receiving and transmitting the signals by the first and second transmirrors.

4. The positioning system of claim 1,
wherein the current position of the moving robot is calculated using the following equations:
(x−X1)²+(y−Y1)²+Z1²=(c*(T1−T1))²; and
(x−X2)²+(y−Y2)²+Z2²=(c*(T2−T2))², and
wherein (x, y, 0) represents the current position of the moving robot, (X1, Y1, Z1) represents the position of the first transmirror, (X2, Y2, Z2) represents the position of the second transmirror, T1 is a time interval between a time point when the moving robot transmits a signal to the first transmirror and a time point when the moving robot receives a signal from the first transmirror, T2 is a time interval between a time point when the moving robot transmits a signal to the second transmirror and a time point when the moving robot receives a signal from the second transmirror, and c is a propagation speed of the signals.

5. The positioning system of claim 1, wherein the moving robot and the transmirrors transmit and receive UWB (ultra wide band) signals therebetween.

6. A position-detecting moving robot, wherein first and second transmirrors are located along a straight surface of a wall which is aligned with an outmost moving course of the moving robot, the moving robot comprising:
a transmitter transmitting signals to the first and second transmirrors;
a receiver receiving signals from the first and second transmirrors; and
a positioning unit determining the position of the moving robot based on time intervals between time points when signals are transmitted to the first and second transmirrors and time points when signals are received from the first and second transmirrors.

7. The moving robot of claim 6, wherein the first and second transmirrors transmit the signals to the moving robot after time intervals [symbol] T1 and [symbol] T2 from time points when the first and second transmirrors receive the signal transmitted from the transmitter.

8. The moving robot of claim 7,
wherein the positioning unit calculates the position of the moving robot by using the following equations:
(x−X1)²+(y−Y1)²+Z1²=(c*(T1−T1))²; and
(x−X2)²+(y−Y2)²+Z2²=(c*(T2−T2))², and
wherein (x, y, 0) represents the current position of the moving robot, (X1, Y1, Z1) represent the position of the first transmirror, (X2, Y2, Z2) represent the position of the second transmirror, T1 is a time interval between a time point when the positioning unit transmits a signal to the first transmirror and a time point when the positioning unit receives a signal from the first transmirror, T2 is a time interval between a time point when the positioning unit transmits a signal to the second transmirror and a time point when the positioning unit receives a signal from the second transmirror, and c is a propagation speed of the signals.

9. The moving robot of claim 6, wherein the moving robot and the transmirrors transmit and receive UWB (ultra wide band) signals therebetween.

10. A positioning method for a moving robot which moves in an indoor environment where first and second transmirrors are provided, the positioning method comprising:
transmitting signals from the moving robot to the first and second transmirrors;
delaying the signals in the first and second transmirrors by time intervals [symbol] T1 and [symbol] T2, and then transmitting the signals to the moving robot; and
determining the position of the moving robot based on time intervals between time points of transmitting the signals to the first and second transmirrors and time points of receiving the signals from the first and second transmirrors.

11. The positioning method of claim 10,
wherein the first and second transmirrors are located along the same straight surface of a wall, and
wherein the straight surface of the wall is aligned with an outmost moving course of the moving robot.

12. The positioning method of claim 10,
wherein the current position of the moving robot is calculated by using the following equations:
(x−X1)²+(y−Y1)²+Z1²=(c*(T1−T1))²; and
(x−X2)²+(y−Y2)²+Z2²=(c*(T2−T2))², and
wherein (x, y, 0) represents the current position of the moving robot, (X1, Y1, Z1) represents the position of the first transmirror, (X2, Y2, Z2) represents the position of the second transmirror, T1 is a time interval between a time point when the moving robot transmits a signal to the first transmirror and a time point when the moving robot receives a signal from the first transmirror, T2 is a time interval between a time point when the moving robot transmits a signal to the second transmirror and a time point when the moving robot receives a signal from the second transmirror, and c is a propagation speed of the signals.

13. The positioning method of claim 10, wherein the moving robot and the transmirrors transmit and receive UWB (ultra wide band) signals therebetween.
